(19) United States
(12) Patent Application Publication
(10) Pub. No.: US 2014/0083322 A1
(43) Pub. Date: Mar. 27, 2014

(54) METHOD OF REMOVING IMPURITIES FROM PLATING LIQUID

(71) Applicant: ROHM AND HAAS ELECTRONIC MATERIALS LLC, Marlborough, MA (US)

(72) Inventor: Yoshiyuki HAKIRI, Niigata (JP)

(73) Assignee: ROHM AND HAAS ELECTRONIC MATERIALS LLC, Marlborough, MA (US)

(21) Appl. No.: 13/625,126

(22) Filed: Sep. 24, 2012

(51) Int. Cl. C09D 1/00

(52) U.S. Cl. 106/1.22

(57) ABSTRACT

Impurities are removed from tin plating liquids by adding additives containing aromatic organic sulfonic acids or salts thereof to the tin plating liquids containing nonionic surface active agents and thiourea or thiourea compounds and producing a precipitate by cooling.

### FIELD OF THE INVENTION

The present invention is directed to a method of removing impurities from tin plating solutions. More specifically, the present invention is directed to a method of removing impurities from tin plating solutions by forming a precipitate of the impurities and removing the impurities from the tin plating solutions without the use of special devices.

### BACKGROUND OF THE INVENTION

In recent years, electroless tin plating has been widely used as a method of plating machine parts, flexible base plates, and printed wiring boards, circuit patterns in electronic parts, etc. The electroless tin plating of these articles is frequently performed by substitution tin plating on copper or copper alloys. When substitution tin plating is performed on copper or copper alloy plating, the substituted copper becomes copper ions and dissolves in the plating liquid; as the plating progresses, the copper ions accumulate. These accumulated copper ions cause the formation of an unacceptable plating film and reduce the performance of the bath; therefore, it is necessary to renew the bath.

The batch and feed-and-bleed methods are known as methods of managing the plating liquid. In the batch method, new plating liquid is used to reconstitute the bath when the plating bath has deteriorated; in electroless tin plating baths, the baths must be renewed whenever the copper concentration rises and the performance of the bath is lowered. This has resulted in problems, such as an increase in work time of making up the baths, reduced productivity, and increased cost of treating the waste baths. Moreover, in the feed-and-bleed method, the plating is continued while the plating bath is caused to overflow. The copper can be removed from the system from the overflow without stopping the plating operation, but it is necessary to supplement a large quantity of plating liquid, and this in fact causes a rise in costs.

Various methods have been proposed as means of solving these problems. For example, in Japanese unexamined patent application No. 5,211,831, a method is described in which part of the plating liquid is removed and the copper thiourea complex in the bath is precipitated by cooling, the copper thiourea complex is removed by filtering, and the filtrate is returned to the plating tank. In Japanese unexamined patent application No. 2002-317275, almost the same operations as in No. 5,211,831 are performed; the copper thiourea complex is precipitated by cooling the plating liquid to below 40° C., and it is removed by filtration.

Moreover, in Japanese unexamined patent application No. 6,120,673, a method is described in which a regeneration cell provided with an anode, a cathode, and a cation/anion exchange membrane is used; the copper is electrolytically deposited on the anode in the electrolysis cell, and the tin ions which pass through the cation exchange membrane are added to the plating solution after it has been electrolyzed and returned to the plating tank. Furthermore, in Japanese unexamined patent application No. 7,226,955, a method is described in which the copper thiourea complex is decomposed by oxidation.

However, according to the inventor's research, the removal of copper by the treatments of the methods described in U.S. Pat. No. 5,211,831 and No. 2002-317275 are insufficient; therefore, a method is needed by which the copper can be removed to a lower concentration. The method described in U.S. Pat. No. 6,120,673 requires a regeneration electrolysis cell, making the device complex. Moreover, the method described in U.S. Pat. No. 7,226,955 requires a reagent and device for oxidizing and dissolving the copper thiourea complex.

### SUMMARY OF THE INVENTION

Methods include adding aromatic organic sulfonic acids or salts thereof to an electroless tin plating liquid including nonionic surface active agents and thiourea or thiourea compounds and producing a precipitate of impurities by cooling; and removing the precipitate of impurities from the electroless tin plating liquid.

The methods enable impurities in tin plating liquids to be removed or reduced to a lower concentration than with conventional methods, without requiring any special devices for removing the impurities in the electroless tin plating liquids.

The inventor performed diligent investigations to solve this problem. As a result, he discovered that the concentration of impurities in an electroless tin plating solution can be reduced to a lower level then with the conventional methods by adding additives containing aromatic organic sulfonic acids or salts thereof to electroless tin plating liquids containing nonionic surface active agents and thiourea or thiourea compounds and producing a precipitate by cooling.

In one aspect of this invention a method includes removing impurities from an electroless tin plating liquid by adding additives containing aromatic organic sulfonic acids or salts thereof to the electroless tin plating liquids containing nonionic surface active agents and thiourea or thiourea compounds and producing a precipitate by cooling.

In another aspect of this invention a method includes regenerating electroless tin plating liquids by adding additives containing aromatic organic sulfonic acids or salts thereof to electroless tin plating liquids containing nonionic surface active agents and thiourea or thiourea compounds after electroless tin plating has been performed on copper or copper alloys using the aforementioned electroless tin plating liquids and removing the precipitate which is produced by cooling.

In yet another aspect a method includes forming electroless tin plating films by using electroless tin plating liquids containing nonionic surface active agents and thiourea or thiourea compounds; part or all of the plating solution removed from the plating tank in which the aforementioned electroless tin plating is performed is recirculated to the aforementioned plating tank by way of a solid/liquid separation device, and an additive containing an aromatic organic sulfonic acid or a salt thereof is added to the aforementioned plating liquid and the precipitate which is produced by cooling is captured and removed by the aforementioned solid/liquid separation device.

In a further aspect a method includes performing electroless tin plating on articles to be plated by using a multiple-tank plating device, which has a main tank in which electroless tin plating is performed, a precipitation tank in which a precipitate is formed, recirculation piping which connects the main tank and the precipitation tank so that the electroless tin plating liquid can be recirculated, and a solid/liquid separation device which is installed between the precipitation tank and the main tank, and also uses a tin plating liquid which contains a nonionic surfactant and thiourea or a thiourea compound; this method includes:

(A) a step in which an additive containing an aromatic organic sulfonic acid or a salt thereof is added to the tin plating liquid in the precipitation tank,
(B) a step in which the tin plating liquid is cooled, and
(C) a step in which the precipitate produced by cooling is captured by using a solid/liquid separation device; and
these steps are performed in the order (A), (B), (C) or (B), (A), (C).

In yet a further aspect a method includes performing electroless tin plating on objects to be plated by using a single-tank plating device which has a plating tank which stores the plating liquid and performs the electroless tin plating, recirculating piping which is connected to the plating tank in such a way that part or all of the plating liquid can be recirculated, a solid/liquid separation device which is installed in the recirculation route of the plating liquid, and a temperature control device which cools or heats the plating liquid in the plating tank, and also uses a tin plating liquid which contains a nonionic surface active agent and thiourea or a thiourea compound; this method includes a step in which the object to be plated is immersed in the plating liquid in the plating tank, a step in which an additive containing an aromatic organic sulfonic acid or a salt thereof is added to the plating liquid and a precipitate is produced by cooling, and a step in which the precipitate produced is removed from the plating liquid using the aforementioned solid/liquid separation device.

In yet an additional aspect a method includes managing an electroless tin plating liquid which contains a nonionic surface active agent and thiourea or a thiourea compound and which is used for electroless tin plating of copper or copper alloys; in this method of managing a plating liquid, the copper ion concentration in the aforementioned plating liquid is reduced by adding an additive containing an aromatic organic sulfonic acid or salt thereof to the plating liquid and producing a precipitate by cooling.

The methods of this invention can reduce impurities in an electroless tin plating liquid to a lower concentration than with conventional methods, without requiring any special devices for removing impurities in the electroless tin plating liquid. Moreover, by removing the impurities, the plating liquid can be used for a long time, and the number of times the plating solution is discarded or newly rebuilt can be greatly reduced. Therefore, it can contribute greatly to improving industrial productivity.

### DETAILED DESCRIPTION OF THE INVENTION

In the specifications and claims, “° C.” means degrees Celsius, “g” means grams, “L” means liters, “mL” means milliliters, “dm” means decimeters, and “μm” means microns or micrometers. Unless otherwise mentioned, all of the quantities are weight percentages. In the specifications and claims, “plating solution”, “plating liquid” and “plating bath” have the same meanings and are used interchangeably. Furthermore, in the specifications and claims, the term “tin plating liquid” does not mean “tin plating liquid” only; it also includes “tin alloy plating liquids.” Similarly, the term “electroless tin plating liquid” does not mean “electroless tin plating liquid” only; it also includes “electroless tin alloy plating liquids.”

In this invention, the plating liquids involved are tin plating liquids; electroless tin plating liquids are especially desirable, and tin plating liquids which can perform substitution tin plating (or substitution tin alloy plating) on copper or copper alloys are still more desirable. Here, as mentioned above, the terms “tin plating liquid” and “electroless tin plating liquid” also include ones which contain other metal components besides tin. The aforementioned tin plating liquids contain water-soluble tin salts or water-soluble tin salts and other metal salts, nonionic surfactants, and thiourea or thiourea compounds as complexing agents.

The water-soluble tin salts used in the tin plating liquid may be any type, as long as they dissolve in water when the plating liquids are made. For example, one can use tin sulfate, stannous chloride, stannous fluoroborate, tin alkane sulfonates, tin alkanol sulfonate, etc.

Moreover, as the other metal salts which can be used together with water-soluble tin salts, one can use salts of lead, copper, silver, bismuth, cobalt, etc.; specific examples of these are lead chloride, lead acetate, lead alkane sulfonates, copper chloride, silver nitrate, bismuth chloride, cobalt sulfate, etc.

The total content of the tin and other metal components besides tin in the plating solution is ordinarily in the range of 10-100 g/L, preferably 30-50 g/L, as the metal.

An acid may be added to the tin plating liquid in order to dissolve the tin or the metal components other than tin. Examples of the acids which can be used are sulfuric acid, hydrochloric acid, alkane sulfonic acids, alkanol sulfonic acids, aromatic sulfonic acids, etc.; these acids may be used individually or in combinations of 2 or more. The total content of the acids added to the plating solution is ordinarily in the range of 1-300 g/L, preferably 50-100 g/L.

The tin plating liquids used in this invention contain thiourea or thiourea compounds. They can act as complexing agents of the dissolved metals, such as copper. From an electrochemical point of view, thiourea or thiourea compounds are well known to persons skilled in the art as components for making substitution tin plating on copper or copper alloys possible, which is theoretically impossible due to the relationship of the standard electrode potentials. The thiourea used may be one which can be ordinarily obtained; one can also use commercial ones.

Thiourea compounds are derivatives of thiourea, for example, 1-methylthiourea, 1,3-dimethyl-2-thourea, trimethylthiourea, diethylthiourea, N,N-diisopropylthiourea, 1(3-hydroxypropyl)-2-thiourea, 1-methyl-3-(3-hydroxypropyl)-2-thiourea, 1-methyl-3-(3-methoxypropl)-2-thiourea, 1,3-bis(3-hydroxypropyl)-2-thiourea, allylthiourea, 1-acetyl-2-thiourea, 1-phenyl-3-(2-thiazolyl)thiourea, benzyl isothiourea, hydrochloride, 1-allyl-2-thiourea, 1-benzoyl-2-thiourea, etc. One or two or more of thiourea and these thiourea compounds may be used. The quantity of thiourea or these thiourea compounds used is ordinarily in the range of 50-250 g/L, preferably 100-200 g/L.

The tin plating liquids used in this invention contain nonionic surfactants. Examples of these nonionic surfactants are octylphenol, alkylamine, alkyl ether, block polymer, naphthyl ether, etc., nonionic surfactants. Specific examples of these are polyoxyethylene octyl phenol, polyoxyether [sic] β-naphthyl ether, polyoxyethylene alkylamine, polyoxyethylene alkyl ether, polyoxyethylene polyoxypropylene cetyl ether, etc. Among these, polyoxyethylene alkyl ether, polyoxyethylene octyl phenol, and polyoxyethylene alkylamine are especially desirable.

One or two or more of these nonionic surfactants may be used. The quantity of these nonionic surfactants used is ordinarily in the range of 1-100 g/L, preferably 5-50 g/L.

The tin plating liquid may contain antioxidants, etc., besides the aforementioned components, if necessary. As antioxidants, one can use catechol, hydroquinone, hypophosphorous acid, etc.

The substitution plating, i.e., electroless tin plating, is performed by constructing an ordinary plating bath and adjusting the temperature within a range of 50-75° C., after which the object to be plated, with a metal such as copper or a copper alloy on its surface, is immersed in the plating liquid for 20-300 seconds. The tin is substituted for the metal such as copper on the surface of the object to be plated and becomes a tin film; in place of it, the metal such as copper on the object to be plated is dissolved in the plating liquid. Therefore, the tin in the plating liquid is consumed as the plating proceeds. Moreover, it is thought that the thiourea or thiourea compound complexing agent forms a complex with the copper or other metal on the object being plated and the thiourea or thiourea compound is also decreased as the plating proceeds. In addition, the acid and other components are reduced as the object being plated is lifted, i.e., scooped up, and are also reduced as the plating proceeds. These components, which are reduced in the plating liquid as the plating proceeds, are replenished in a suitable way. However, the eluted metal, such as copper, increases as the plating proceeds and accumulates in the bath; thus, the quality of the plating film becomes worse and the performance of the bath is lowered.

This invention is characterized by the fact that an additive containing an aromatic organic sulfonic acid or a salt thereof, also referred to below as “aromatic organic sulfonic acids”, is added to a tin plating liquid which contains a nonionic surfactant and a precipitate containing an eluted metal, such as copper, which is an impurity, is produced by cooling, suppressing the accumulation of the eluted metals such as copper in the plating liquid. By adding the additive containing an aromatic organic sulfonic acid to the plating liquid and cooling the plating liquid, the eluted metal complex, such as a copper ion complex, dissolved in the plating liquid is made to precipitate, so that the concentration of the eluted metal ions, such as copper ions, in the plating liquid can be reduced. Furthermore, “precipitating a precipitate by cooling” includes the case in which the precipitate is precipitated by cooling after the additive containing an aromatic sulfonic acid is added to the plating liquid, and the case in which the plating liquid is cooled in a range in which the precipitate is not precipitated, after which the aromatic sulfonic acid additive is added and the precipitate is precipitated.

The concentration of elute metals such as copper in the plating liquid after the precipitate is produced by the method of this invention is much lower than with the methods of the prior art. The detailed reaction mechanism is unknown, but it is thought that the eluted metal ions, such as copper ions, in the plating liquid are present as a thiourea or thiourea compound complex, and it is thought that when the nonionic surfactant and aromatic organic sulfonic acid are present, the solubility of the thiourea or thiourea compound complex is lowered at a low temperature, so that the precipitate is formed. The nonionic surfactant is thought to make some contribution to the precipitate formation together with the aromatic organic sulfonic acid; specific ones can be selected as the nonionic surfactants in order to form the precipitate more efficiently.

As mentioned above, aromatic organic sulfonic acids or salts thereof are contained in the additives added to the tin plating liquid in this invention. In the specifications and claims, the term “aromatic organic sulfonic acids” refers to aromatic organic sulfonic acids and/or these additives. Moreover, the term “includes aromatic organic sulfonic acids or salts thereof” not only refers to the case in which either one of aromatic organic sulfonic acids or salts of aromatic organic sulfonic acids is included, but also the where both are included. Examples of the aromatic organic sulfonic acids are phenolsulfonic acid, benzenesulfonic acid, toluenesulfonic acid, and naphthalenesulfonic acid, as well as hydrates, etc., of the aforementioned aromatic organic sulfonic acids. Moreover, the salts of the aromatic organic sulfonic acids may be any desired salts, for example, sodium, potassium, ammonium, etc., salts. The aromatic organic sulfonic acids and their salts may be used as mixtures.

The additives containing aromatic organic sulfonic acids or salts thereof may also contain other components besides the aromatic organic sulfonic acids. For example, ingredients which are consumed or reduced as the plating proceeds, for example, nonionic surfactants, thiourea, thiourea compounds, and acids, may be contained in these additives, and these components can be replenished in the plating liquid by adding these additives. Moreover, the additives may be either solid or liquid; for example, the additives may be in the state of aqueous solutions in which the aromatic organic sulfonic acids and other optional ingredients are dissolved in water. By making aqueous solutions of the additives, it becomes easy to control the quantities of the aromatic organic sulfonic acids and other optional ingredients that are added.

The quantities of the additives added are such that the concentrations of the aromatic organic sulfonic acids or their salts in the tin plating liquid are in the range of 5-200 g/L, preferably 20-100 g/L, and especially preferably 50-100 g/L. If the quantity added is small, the precipitate will not be produced. In order to obtain sufficient precipitate, it is desirable for the aromatic organic sulfonic acids or their salts to be used in quantities such that their concentration becomes 20 g/L or higher. If the quantity used is too great, the performance of the bath will be lowered: the state of precipitation of the tin will be worsened and the precipitation speed will be lowered, etc.

It is desirable for the quantity of the additive added to be determined by the copper concentration in the bath. In order to remove 1 g of copper, 1-30 g of aromatic organic sulfonic acid or its salt, preferably 1-20 g, and especially preferably 2-10 g, are added. If the quantity added is small, the precipitate will not be produced. If the quantity used is too great, and a large quantity of the aromatic organic sulfonic acid remains in the bath after the copper is removed, the performance of the bath will be lowered: the state of precipitation of the tin will be worsened and the precipitation speed will be lowered, etc.

A first method of this invention is a method of removing impurities from a plating liquid by adding additives containing aromatic organic sulfonic acids or salts thereof to electroless tin plating liquids containing nonionic surface active agents and thiourea or thiourea compounds and producing a precipitate by cooling.

Here, the tin plating liquid to which the additive containing an aromatic organic sulfonic acid is added is preferably one which has already been used in tin plating, especially electroless tin plating. In the case of electroless tin plating, if it is a liquid which has already been used in electroless tin plating, it may be a plating liquid after the electroless tin plating treatment has been completed, or one in which the electroless tin plating treatment is at an intermediate stage. Examples of the impurities are copper and other metals, for example, nickel, zinc, chromium, molybdenum, tungsten, etc., eluted from the object being plated. The impurity is especially copper; copper can be removed effectively from the plating liquid by this invention. As mentioned above, when an additive containing an aromatic organic sulfonic acid is added to a plating liquid which has been used in plating and has an increased concentration of eluted metals, such as copper, the insoluble component containing the eluted metal such as copper is precipitated by cooling. By removing this insoluble component, the eluted metals such as copper can be removed from the plating liquid. Any desired method can be used to remove the insoluble component, for example, filtration, sedimentation separation, centrifugal separation, etc.

A second method of this invention is a method of regenerating plating liquids by adding additives containing aromatic organic sulfonic acids or salts thereof to electroless tin plating liquids containing nonionic surface active agents and thiourea or thiourea compounds after electroless tin plating has been performed on copper or copper alloys using the aforementioned electroless tin plating liquids and removing the precipitate which is produced by cooling.

As mentioned above, by removing the precipitate which was precipitated by adding an additive containing an aromatic organic sulfonic acid to the plating liquid and cooling, the impurities, especially the eluted metals such as copper, can be removed from the plating liquid. After the precipitate is removed, the plating liquid can be reused; it can be continued in use as a plating liquid by replenishing the consumed or reduced other components. Therefore, it becomes unnecessary to discard aged plating liquid, and the industrial productivity can be improved. The replenishing of the ingredients which are consumed or reduced can be performed by adding the ingredients to be replenished, e.g., the nonionic surfactant, thiourea, thiourea compound, tin, acid, etc., to the additive together with the aromatic organic sulfonic acid.

A third method of this invention is a method of forming electroless tin plating films by using electroless tin plating liquids containing nonionic surface active agents and thiourea or thiourea compounds; part or all of the plating solution removed from the plating tank in which the aforementioned electroless tin plating is performed is recirculated to the aforementioned plating tank by way of a solid/liquid separation device, and an additive containing an aromatic organic sulfonic acid or a salt thereof is added to the aforementioned plating liquid and the precipitate which is produced by cooling is captured and removed by the aforementioned solid/liquid separation device.

In this method, also, the cooling of the plating liquid may be performed the additive containing the aromatic organic sulfonic acid is added, to a temperature in a range in which the precipitate does not appear, or it may be cooled to a temperature at which the precipitate is produced after the additive containing the aromatic organic sulfonic acid is added. The recirculation of the electroless tin plating solution is preferably performed once the plating operation is paused. Moreover, the adding of the additive containing an aromatic organic sulfonic acid may be performed once the plating operation is stopped, and the consumed or decreased necessary components of the plating liquid are replenished in the plating solution after the precipitate is removed, as well as heating the plating solution to a suitable temperature for plating, after which the plating is restarted. The replenishing of the aforementioned necessary ingredients can be performed by adding the necessary ingredients, for example, the nonionic surfactant, thiourea, thiourea compound, acid, etc., by making them to be contained in the additive together with the aromatic organic sulfonic acid.

The solid/liquid separation device may be any one which can separate the plating liquid and the precipitate produced; for example, one can use filtration using a filter, sedimentation separation, centrifugal separation, etc. Here, the addition of the additives containing aromatic organic sulfonic acids is preferably performed with respect to the plating liquid which has deteriorated due to the plating operation, that is, with respect to the plating liquid the bath performance of which has been lowered in the process of plating the objects being plated by the elution of the metal ions, e.g., copper, nickel, zinc, chromium, molybdenum, tungsten, etc., ions. As mentioned above, the plating film is formed by constructing an ordinary plating bath and adjusting the temperature within a range of 50-75° C., after which the object to be plated, with a metal such as copper or a copper alloy on its surface, is immersed in the plating liquid for 20-300 seconds. As the plating proceeds, the copper ions are eluted into the plating liquid; therefore, the addition of the additive containing the aromatic organic sulfonic acid, the cooling of the plating liquid, the recirculating of the liquid, and the capture and removal of the precipitate may be performed in the necessary order and with the necessary timing.

A fourth method of this invention is a method of performing electroless plating on articles to be plated by using a multiple-tank plating device, which has a main tank in which electroless tin plating is performed, a precipitation tank in which a precipitate is formed, recirculation piping which connects the main tank and the precipitation tank so that the electroless plating liquid can be recirculated, and a solid/liquid separation device which is installed between the precipitation tank and the main tank, and also uses a tin plating liquid which contains a nonionic surfactant and thiourea or a thiourea compound; this method includes

(A) a step in which an additive containing an aromatic organic sulfonic acid or a salt thereof is added to said plating liquid in the precipitation tank,
(B) a step in which the plating liquid is cooled, and
(C) a step in which the precipitate produced by cooling is captured by using a solid/liquid separation device; and
these steps are performed in the order (A), (B), (C) or (B), (A), (C).

The fourth method of this invention is characterized by the use of a multi-tank device which is provided with a precipitation tank for forming the precipitate as well as the main tank, in which the electroless plating is performed. At least two tanks are necessary, but one may also use three or more tanks, as necessary. The main and precipitation tanks used may have any desired sizes and shapes, as long as they can perform the respective plating treatment and precipitation formation. Temperature regulating devices are preferably installed in the main and precipitation tanks; heating is primarily performed in the main tank and cooling is primarily performed in the precipitation tank. The main and precipitation tanks are connected by piping in such a way that the electroless plating liquid can be circulated between the two tanks. The piping may be of any kind, as long as the plating liquid can be circulated. Moreover, a solid/liquid separation device may be installed in the path by which the plating liquid flows from the precipitation tank to the main tank, and the precipitate formed by adding the additive containing an aromatic organic sulfonic acid and cooling can be separated. The steps (A)-(C) may be performed in the order (A), (B), (C) or (B), (A), (C).

In either of these orders, the precipitate is formed in the precipitation tank while the plating operation is continued in the main tank; this has the advantage that it is not necessary to stop the plating operation. The temperature of the plating liquid in the main tank is preferably in the range of 50-75° C., and the temperature of the plating liquid of the plating tank is preferably in the range of 5-30° C. The method of capturing the precipitate produced in the steps of (A) adding the additive containing an aromatic organic sulfonic acid or a salt thereof to the plating liquid, (B) cooling the plating liquid, and (C) capturing the precipitate using a solid/liquid separation device is as described above.

A fifth method of this invention is a method of performing electroless tin plating on the objects to be plated by using a single-tank plating device which has a plating tank which stores the plating liquid and performs the electroless tin plating, recirculating piping which is connected to the plating tank in such a way that part or all of the plating liquid can be recirculated, a solid/liquid separation device which is installed in the recirculation route of the plating liquid, and a temperature control device which cools or heats the plating liquid in the plating tank, and also uses a tin plating liquid which contains a nonionic surface active agent and thiourea or a thiourea compound; this method includes a step (A) in which the object to be plated is immersed in the plating liquid in the plating tank, a step (B) in which an additive containing an aromatic organic sulfonic acid or a salt thereof is added to the plating liquid and a precipitate is produced by cooling, and a step (C) in which the precipitate produced is removed from the plating liquid using the aforementioned solid/liquid separation device.

The fifth method of this invention is characterized by the use of a single-tank device in which a single-tank plating device is used to form a precipitate by adding an additive containing an aromatic organic sulfonic acid to the plating tank in which the electroless plating is performed. The plating tank used may have any desired sizes and shapes, as long as it can perform the plating treatment and the precipitation formation. The temperature control device may be of any form as long as the plating liquid can be regulated to the desired temperature. As mentioned above, any desired form of the circulation piping and solid/liquid separation device may be used.

In step (A), the object to be plated is immersed in the plating solution in the plating tank and substitution plating is performed. The temperature of the plating liquid in the plating tank is preferably in the range of 50-75° C. As the substitution plating proceeds in the plating tank, copper ions eluted from the object being plated accumulate in the plating liquid. In step (B), an additive containing an aromatic organic sulfonic acid is added to the plating liquid in the plating tank. The method of addition is as mentioned above. Moreover, in step (B), the plating liquid in the plating tank to which the additive containing an aromatic organic sulfonic acid has been added is cooled. The cooling may be performed before or after the additive containing an aromatic organic sulfonic acid is added. The temperature of the plating liquid at the time of the cooling is preferably in the range of 5-30° C., as mentioned above. Since the plating temperature is below the range which is suitable for plating during step (B), the plating operation must be stopped. In step (C), the precipitate produced in the plating tank is sent to the solid/liquid separation device through the circulation piping and separated and removed from the plating liquid. The recirculation of the plating liquid must be performed after step (B) is finished.

A sixth method of this invention is a method of managing an electroless tin plating liquid which contains a nonionic surface active agent and thiourea or a thiourea compound and which is used for electroless tin plating of copper or copper alloys; in this method of managing a plating liquid, the copper ion concentration in the aforementioned plating liquid is reduced by adding an additive containing an aromatic organic sulfonic acid or salt thereof to the plating liquid and producing a precipitate by cooling.

In a plating tank of any of the types mentioned above, the copper concentration in the plating liquid is measured, the additive containing the aromatic organic sulfonic acid is added to the plating liquid at a suitable time before the copper concentration reaches an upper limit where it will have a bad effect on the plating, and then the plating liquid to which the additive containing the aromatic organic sulfonic acid was added is cooled, producing a precipitate and thereby reducing the copper ion concentration in the plating liquid and controlling the electroless plating liquid to the optimum state. The measurement of the copper ions in the plating liquid can be performed by any desired method, for example, the copper ion concentration can be measured by sampling part of the plating liquid and measuring by atomic absorption or ICP.

### WORKING EXAMPLES

### Working Examples 1-5

Electroless plating solutions with the following compositions were prepared:
Tin fluoborate (as Sn²⁺): 37 g/L
Methanesulfonic acid: 50 g/L
Hypophosphorous acid: 30 g/L
Thiosulfate: 100 g/L
Nonionic surfactants of Table 1: 50 g/L

TABLE 1

| Working Example | Nonionic surfactant |
|---|---|
| 1 | Polyoxyethylene octyl phenol |
| 2 | Polyoxyethylene alkylamine |
| 3 | Polyoxyethylene cetyl ether |
| 4 | Polyoxyethylene β-naphthyl ether |
| 5 | Polyoxyethylene-polyoxypropyelen cetyl |
| | ether |

Twenty g/L of copper powder were added to each of the aforementioned tin plating liquids and they were heated for 5 hours at 65° C. while stirring. When the substitution reaction of the copper and tin was completed, electroless tin plating liquids which were deteriorated by containing copper ions were made. These simulated deteriorated plating liquids were kept at 65° C.; 70 g/L paratoluenesulfonic acid was added as the additive, and the plating liquid was cooled to 25° C. After the plating solution was cooled, a free substance was produced in the plating liquid. The free substance was removed by passing the plating solution through a filter (0.2 microns) and the copper concentrations in the plating solutions after the filtration were measured by atomic absorption. The results are shown in Table 2.

TABLE 2

| | Working Example | | | | |
|---|---|---|---|---|---|
| | 1 | 2 | 3 | 4 | 5 |
| Residual copper concentration (g/L) | 2.8 | 5.7 | 1.3 | 0.5 | 0.5 |
| Copper removal percentage (%) | 83 | 65 | 92 | 97 | 97 |
| Residual aromatic sulfonic acid | 22.0 | 30.8 | 20.3 | 17.8 | 18.6 |
| concentration (g/L) | | | | | |
| Residual thiourea concentration (g/L) | 58.1 | 64.4 | 57.7 | 56.8 | 54.2 |

### Working Example 6

Benzene sulfonic acid was used instead of the paratoluenesulfonic acid of Working Example 4; benzenesulfonic acid was added as the additive to the simulated deteriorated liquid containing copper ions, kept at 65° C. in the same manner as in Working Example 4, and the plating liquid was cooled to 25° C. After the plating solution was cooled, a free substance was produced in the plating liquid. The free substance produced was caused to precipitate, the supernatant liquid was sampled, and the copper concentration in the plating solution was measured by atomic absorption. The measured copper concentration was 0.4 g/L.

### Working Example 7

A simulated deteriorated electroless tin plating liquid containing copper ions was made by the same operations as in Working Example 3. The aforementioned simulated deteriorated plating liquid was cooled to 30° C. No free substance was produced at this time. The simulated deteriorated plating liquid was kept at 30° C. and 70 g/L paratoluenesulfonic acid was added. A free substance was produced in the plating liquid immediately after it was added. The free substance was removed by passing the plating solution through a filter (0.2 microns) and the copper concentrations in the plating solutions after the filtration were measured by atomic absorption. The measured copper concentration was 0.9 g/L.

### Comparison Example 1

The same operations were performed as in Working Example 1, except that the nonionic surfactant was not used; the copper concentration in the plating liquid after the filtration was measured by atomic absorption. The results are shown in Table 3.

When the nonionic surfactant was not used, the copper removal percentage was worse than in Working Examples 1-7, and it was found that the aromatic organic sulfonic acid was not consumed.

TABLE 3

| | Comparison Example |
|---|---|
| | 1 |
| Residual copper concentration (g/L) | 8.6 |
| Copper removal percentage (%) | 47 |
| Residual aromatic sulfonic acid concentration | 69.1 |
| (g/L) | |
| Residual thiourea concentration (g/L) | 73.7 |

### Comparison Example 2

The same operations were performed as in Working Example 2, except that isethionic acid was used instead of the paratoluenesulfonic acid; the copper concentration in the plating liquid after the filtration was measured by atomic absorption. The measured copper concentration was 7.2 g/L.

### Comparison Example 3

The same operations were performed as in Working Example 2, except that isethionic acid was used instead of the paratoluenesulfonic acid and the nonionic surfactant was not used; the copper concentration in the plating liquid after the filtration was measured by atomic absorption. The measured copper concentration was 7.4 g/L.

### Working Example 8

An impurity repeated removal test and a test evaluating the plating performance after the impurities were removed were performed. Using a plating liquid similar to that of Working Example 4, electroless tin plating was performed under the following conditions. Copper was added in the same manner as in Working Example 4, making a simulated deteriorated plating solution, and electroless tin plating was performed using this simulated deteriorated plating liquid. After this, paratoluenesulfonic acid was added as in Working Example 1, and, after plating, the impurities were filtered out. Additional consumed thiourea, nonionic surfactant (polyoxylethylene β3-naphthyl ether), and tin fluoborate, etc., were added to the plating liquid after the filtering, adjusting the concentrations to the same concentrations as in the plating liquid before the copper was added. These operations were performed a total of 4 times.

The results are shown in Table 4.
Plating conditions: temperature, 65° C.; plating time, 195 seconds.

TABLE 4

| | | After | After | After | After | After | After | After | After |
|---|---|---|---|---|---|---|---|---|---|
| | Before | copper | copper | copper | copper | copper | copper | copper | copper |
| Plating | copper | is added | is removed | is added | is removed | is added | is removed | is added | is removed |
| liquid | is added | (1) | (1) | (2) | (2) | (3) | (3) | (4) | (4) |
| Copper | 0 | 14.4 | 0/9 | 15.6 | 0.6 | 13.6 | 0.6 | 12.6 | 0.5 |
| concentration | | | | | | | | | |
| (g/L) | | | | | | | | | |
| Plating | 0.51 | 0.43 | 0.51 | 0.42 | 0.51 | 0.42 | 0.5 | 0.42 | 0.51 |
| thickness | | | | | | | | | |
| (μm) | | | | | | | | | |

What is claimed is:

1. A method comprising adding aromatic organic sulfonic acids, hydrates thereof, or salts thereof to an electroless tin plating liquid comprising nonionic surface active agents and thiourea or thiourea compounds and producing a precipitate of impurities by cooling; and removing the precipitate of impurities from the electroless tin plating liquid.

2. The method of claim 1, further comprising contacting copper or copper alloy with the electroless tin plating liquid to plate tin on the copper or copper alloy.

3. The method of claim 1, wherein the precipitate of impurities is removed by a solid/liquid separation device.

4. The method of claim 1, wherein the aromatic organic sulfonic acids or salts thereof are in amounts of 5-200 g/L.

5. The method of claim 1, wherein the aromatic organic acids are chosen from phenolsulfonic acid, benzenesulfonic acid, toluenesulfonic acid, and naphthalenesulfonic acid.

6. The method of claim 1, wherein the precipitate of impurities comprises one or more of ions of copper, nickel, zinc, chromium, molybdenum and tungsten.
